(19) United States
(12) Patent Application Publication
(10) Pub. No.: US 2017/0217346 A1
(43) Pub. Date: Aug. 3, 2017

(54) PORTABLE OBJECT CATCHING APPARATUS

(71) Applicant: Jessica Knapp, Nampa, ID (US)

(72) Inventor: Jessica Knapp, Nampa, ID (US)

(21) Appl. No.: 15/416,075

(22) Filed: Jan. 26, 2017

Related U.S. Application Data
(60) Provisional application No. 62/288,416, filed on Jan. 28, 2016.

(51) Int. Cl. B60N 2/60; B64D 11/06; B60N 2/44

(52) U.S. Cl. CPC B60N 2/60; B60N 2/44; B64D 11/06

(57) ABSTRACT

A object catching device for use in transportation vehicle, comprising a main section having a generally rectangular shape, the main section adapted to cover the area between two seats and the main section having a rear portion adapted to secure to the back portion of a seat, the front portion adapted to secure in front of the seat, and the side portions to extend upwards a predetermined height.

### BACKGROUND OF THE INVENTION

The present invention generally relates to a portable object catching apparatus. More particularly, the present invention relates to a portable object catching apparatus for use in a vehicle such as car, train and plane to prevent food, toys and other items dropped by a child from falling on the floor thereby keeping the items clean and easily accessible near the child.

Child safety seats are required by law in many jurisdictions of the United States. That is, caretakers of young children are often mandated to restrain their child in government approved restraint seats while the child is seated, thereby reducing the probability of injury to the child in the event of an accident. To increase safety, many public transportation systems accommodate child safety seats. Child safety seats provide a location for comfortably seating a child, a mechanism for securing the child therein, and locations wherein the child safety seat is attached.

Children tend to become bored without a sufficient amount of stimulation when secured in their seats, which can lead to distraction of the driver of the automobile if the child becomes disruptive or an issue for other occupants of the vehicle. Many times the children are given toys or items to play with to entertain themselves while traveling. However many children tend to throw or drop the items in front of them as they play with them, and are unable to retrieve the item once it is out of reach. Many times, the parents or guardians are out of reach of the item, or it would be dangerous to reach for the toy, or if the dropped item is food the parent does not want the child to eat the food off the ground.

Therefore it is desired to have an apparatus to catch the toys or food that a child may drop so they are can be easily retrieved by the child and the toys or food remain sanitary. The following disclosure describes a device that is adapted for securing to the front of a child's seat and the rear portion of the seat in front of them that will catch any dropped items or can be used to hold items as well.

### SUMMARY

A portable object catching apparatus is disclosed for use in a vehicle such as a car, a train and plane to prevent toys, food and other items dropped by a child from falling on the floor thereby keeping the items clean and easily accessible near the child. The apparatus includes a piece of fabric, two straps at the edges of the front end of the fabric to connect the apparatus to a seat or table tray in front of a child, an elastic rear end of the fabric to connect the apparatus to the seat on which the child sits. The apparatus further includes a storage pocket for storing articles such as diapers, wipes, toys, etc. when the apparatus is positioned in the vehicle for use. Once used, the fabric and the straps are compactly folded and placed inside the storage pocket for compactly storing and transporting the apparatus.

Preferred embodiments, wherein the main section has an opening distal to the rear portion on at least one of the sides to allow for a seat belt to pass through. Wherein the upper edge of the rear portion is elastic. Wherein the front portion has at least two elongated straps. Wherein each of the at least two elongated straps have a fastening mechanism to secure the front portion to a structure. Wherein the fastening mechanism is a hook and loop style fastener. Wherein the interior surface of the main section is covered in a water-resistant coating. Wherein the exterior surface of the main section is covered in a water-resistant coating. Wherein the main section is a unitary design.

### BRIEF DESCRIPTION OF THE DRAWINGS

FIG. 1 depicts a side view of the catching device installed in a vehicle, in accordance with one embodiment of the present invention.

FIG. 2 depicts a top view of the catching device, in accordance with one embodiment of the present invention.

FIG. 3 depicts a side view of the catching device, in accordance with one embodiment of the present invention.

### DETAILED DESCRIPTION OF THE INVENTION

The products of the present invention provide portable object catching apparatus for use in a vehicle such as a car, train, or plane and is used to prevent food, toys, or other items dropped by a child or infant from falling onto the floor, thereby keeping the items clean and easily accessible near the child.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. It is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Unless defined otherwise, all technical and scientific terms used herein have the same meaning as commonly understood by one of ordinary skill in the art to which this invention belongs. Although any methods and materials similar or equivalent to those described herein may also be used in the practice or testing of the present invention, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It must be noted that as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

Embodiments of the present invention provide a portable object catching apparatus for use in vehicle such as car, train and plane to prevent toys, food and other items dropped by a child from falling on the floor thereby keeping the items clean and easily accessible near the child. Accordingly, the specific embodiments discussed herein are merely illustrative of specific manners in which to make and use this invention, and are not intended to represent an exhaustive list of all possible structure and processes of the present invention.

Embodiments of the portable object catching apparatus are discussed below. While the structure and processes have been described with a certain degree of particularity, it is to be noted that many modifications may be made in the details of the structure and processes without departing from the spirit and scope of this disclosure. It is understood that the structure and processes are not limited to the embodiments set forth herein for purposes of exemplification.

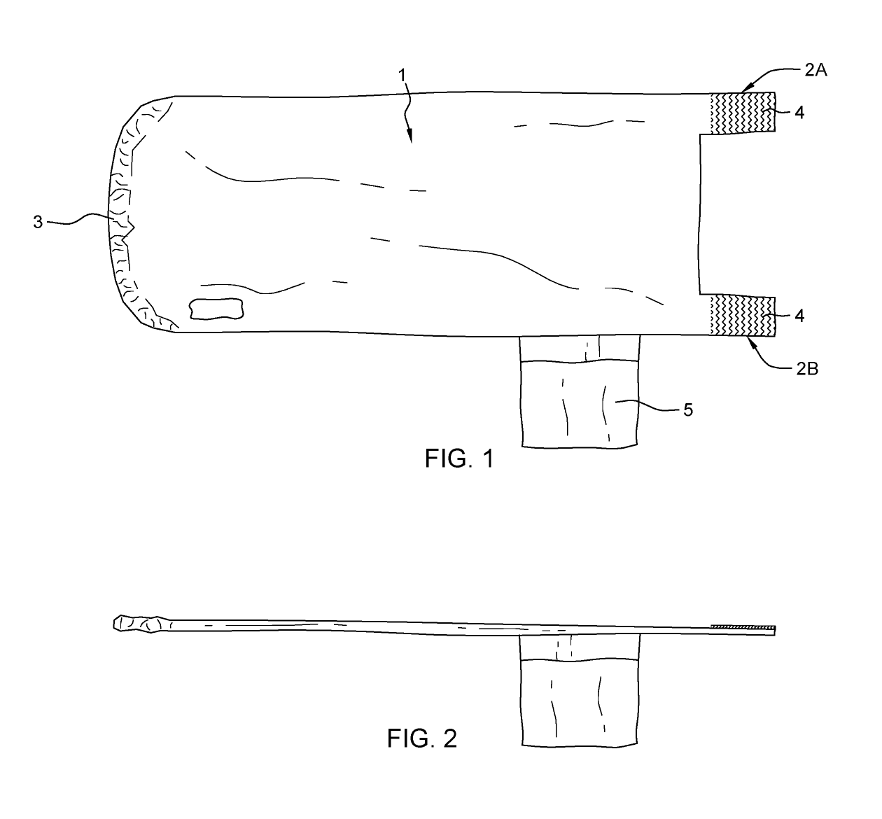

FIGS. 1-2 depicts views of the catching device, in accordance with one embodiment of the present invention. As depicted in FIG. 1, the catching device has a main compartment 1, a plurality of tabs 4 with an attachment means 2, a rear attachment means 3, a plurality of pockets 5, and a plurality of seat belt openings 6.

The catching device has the main compartment 1 with a plurality of tabs 4 that have the attachment means 2 affixed to the tabs 4 and the rear attachment means 3 integrated into the main compartment 1. In the depicted embodiment, the main compartment 1, the plurality of tabs 4 and the rear attachment means 3 are a unitary design. In additional embodiments, the elements are individual elements attached together. The main compartment 1 is made from various fabrics such as cotton, spandex or the like. In some embodiments, the main compartment 1 has a water proof layer to keep liquids from penetrating the interior of the main compartment 1. In some embodiments, the main compartment 1 has a water proof layer to keep liquids from penetrating the exterior of the main compartment 1. The length of the main compartment 1 is designed to be able for the rear attachment means 3 to attached to the back of the child's car seat, the bottom of the seat back, or the rear portion of the seat base, and the front attachment means 4 to attached to the seat in front of the child. The main compartment 1 may extend substantially parallel to the seat of the child. There may slack so that in front of the seat of the child there is a section that is lower than the child to catch the toys or food in front of the search. There may also be less slack and the front portion of the main compartment slants down toward the child so that anything that is dropped rolls back towards the child to allow for the child to access to the items even easier.

In the depicted embodiment, the front attachment means 4 affixed to the plurality of tabs 2 which are designed to attach to the seat in front of where the child is sitting. Typically they attached near the headrest or in the seat pocket, but the attachment means may also attached to itself around an object. This is accomplished by the front attachment means 4 having a mate and female portion of an attachment means affixed to each of the tabs 4. In one embodiment, tabs 4 have a hook and loop style fastening mechanism to allow for some adjustability in the tightness of the catching device around the seat in front of where the child is situated. In additional embodiments, the tabs 4 may have various fastening mechanisms such as clasps, latches, ties, clips, or the like. The length of the tabs 4 is predetermined based on the intended use of the catching device. For example, the space in an automobile may be to small for the apparatus to be used on a train or in a plane. Thus in these cases, extensions of material with the proper fastening means may be used to extend the reach of the tabs 4. The extensions may be made from the same material as the catching device, and are a predetermined length based.

The rear attachment means 3 is designed to attached to the seat behind the child so the child is sitting within the main compartment 1. In the depicted embodiment, the rear attachment means 3 is an elastic portion that is designed to fit under the backrest of the child's seat and the elastic portion is used to hold the catching device in place and prevent the catching device from slipping off of the child's seat. In additional embodiments, the rear attachment means 3 may have an anti-slip coating to further secure the catching device to the seat. Examples of anti-slip coatings are epoxies, rubber, tapes adhesives, or the like.

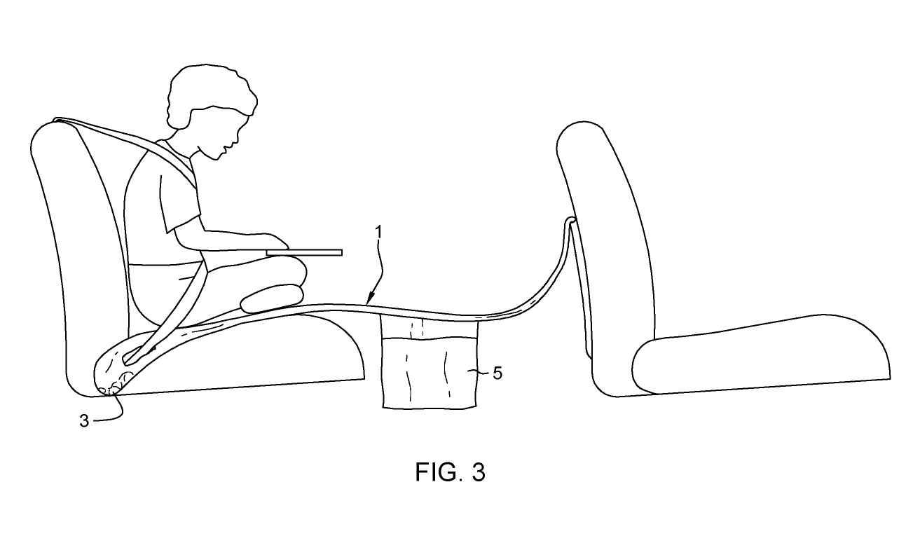

FIG. 3 shows the catching device installed in accordance with one embodiment. The catching device sits under base of the seat with the child sitting on top of the main compartment 1. In additional embodiments, the catching device can be attached to the seat back or around a car seat in car, train or plane. The main compartment 1 spans to the back of the seat in front of the child. The main compartment 1 is connected to the back of the seat in front of the child. Alternatively, the main compartment 1 may be connected to a tray table positioned in front of the child. The tabs 4 may be wrapped around the arms of a tray table in front of the child's seat and then fastened to itself using the hook and loop or various types of fasteners. The fastener used on the tabs 4 allows for expansion in length between the seat and the child to accommodate the distance between seats in the plane or the position of the seat in front of the child in the vehicle. In one embodiment, the if snap buttons are used as a fastening means, the snaps are present at three different snapping positions on the tabs 4 to allow for variation in distance. Similarly button can have 2-3 different positions on the straps to allow for variation in distance.

In the depicted embodiment, the seat belt opening 6 allows the seat belt to be used without interfering with the catching device. This seat belt opening 6 may be located on one or both sides of the main compartment 1 to allow a more versatile application of the catching device based on where the seat belt is locate for each seat. As it is common for the seat belt to attached around the waist so an opening on each side of the main compartment 1 would be desired.

The rear attachment means 3 fits around the back of the seat of the car, plane seat or other child seat on which the child sits. Most bottom seat cushions are similar and the elastic rear attachment 3 means stretches and conforms to slight variations of the seats. The rear attachment means 3 may slide under the lower back portion of the child's car seat, it may encase a portion of the lower portion of the seat typically around the back edge, or it may encase a portion of the bottom part of the seat back. In some embodiments, the rear attachment means 3 is an alternative fastening mechanism such as a hook and loop style fastener, a clasping fastener, a zipping fastener, or the like. The elasticity of the rear attachment means 3 is preferably provided by an elastic string present at the rear end of the catching device. Alternatively, an elastic strip may be used.

Once the apparatus is in use position in the vehicle, the child can sit over the apparatus. The apparatus is thus held in place on the seat on which the child sits, by the elastic and the child's weight. While the apparatus is positioned over the child's seat, the seat belt remains exposed and can be conveniently fastened around the child. This is specifically useful while using the apparatus in a plane or other vehicles. The apparatus allows use of seatbelt without a hindrance and ensure that the security is not compromised while the apparatus is performing its function. The child is able to comfortably move all parts of their body freely. The child is able to eat food, play with toys and perform other activities while sitting on the apparatus. If an item is dropped by the child sitting over the apparatus, the item is easily accessible near the child on the apparatus. The apparatus catches all the toys, items and food dropped that may hit the dirty floor, roll under the seat out of reach, etc. It also protects the seat to pick up spills that may damage the seat material. The apparatus also provides support to the legs of the child when the child is asleep.

In some embodiments, the rear portion of the catching device can be rolled up or tucked behind the seat or car seat to create a tighter area for the child to sit in. This can be because the distance between the seat is smaller depending on the vehicle.

Additionally, the side walls of the catching device are adjustable so as to create a contained area for the child to be in so food and toys are not easily to fall out of the internal area. In one embodiment, the side walls are approximately 2 inches in height if the child is buckled into the seat. In one embodiment, the side walls are approximately 4-6 inches in height if the child is in a car seat. This is to allow the catching device to securely attach to the car seat.

In the depicted embodiment, the catching device includes a storage pocket 5 connected to main compartment 1 on both sides. Alternatively, a storage pocket 5 connected on only one side of the piece of fabric. The storage pocket 5 has an opening and a freely hanging elongated enclosure. The piece of fabric with its straps can be easily folded and placed inside the storage pocket converting the storage pocket 5 into a storage bag. The storage pocket 5 has a means to close and lock the pocket to keep items secured inside. Various closing means such as hook and loop, clips, clamps, zippers, buttons, and the like can be used. The storage pocket 5 is preferably situated about a ⅓rd of the way from the front end. This location of the storage pocket 5 allows a convenient storage of the articles inside the storage pocket 5. The storage pocket 5 may be connected 15 cm away from the front end.

The apparatus may be constructed from a flexible, durable, lightweight material which can be folded to enhance portability. The material is preferably slightly stretchy. The material may be water-resistant or waterproof so that the apparatus may be easily cleaned and/or disinfected after use. The material may be flame resistant. As discussed earlier, the apparatus is preferably made from fabric including woven and non-woven fabric, but other suitable materials for construction of the apparatus such as, but not limited to flexible plastic film materials such as vinyl, plastics, polymeric materials, and composite materials are not precluded. The apparatus may also be made from recycled material or organic material.

The apparatus is preferably rectangular shaped. The apparatus for use in plane, preferably includes 55 cm wide and 115 cm long fabric with 30 cm long straps. The storage pocket storing the apparatus is 30 cm long and 20 cm wide. The span of the apparatus is standard so that there is not too much slack between the edge of the seat and the tray table or front seat in a car. Both distances are similar and again the stretch of the fabric can make for an easier transition without variation of the apparatus. Also, the size of the apparatus is contoured to fit the back of an airline seat, car seat and train seats. The apparatus has decorative patterns such as colorful prints, and designs including but not limited to cartoon characters, flowers, animals etc.

It is to be understood that the above description is intended to be illustrative, and not restrictive. For example, the above discussed embodiments may be used in combination with each other. Many other embodiments will be apparent to those of skill in the art upon reviewing the above description.

Whereas, the construction and method have been described in relation to the above-given embodiments, it should be understood that other and further modifications, apart from those shown or suggested herein, may be made within the spirit and scope of this invention.

While this invention has been described in conjunction with the specific embodiments outlined above, it is evident that many alternatives, modifications and variations will be apparent to those skilled in the art. Accordingly, the preferred embodiments of the invention, as set forth above, are intended to be illustrative, not limiting. Various changes may be made without departing from the spirit and scope of this invention.

What is claimed is:

1. A object catching device for use in transportation vehicle, comprising:
a main section having a generally rectangular shape, the main section adapted to cover the area between two seats and the main section having a rear portion adapted to secure to the back portion of a seat, the front portion adapted to secure in front of the seat, and the side portions to extend upwards a predetermined height.

2. The object catching device of claim 1, further comprising:
a pouch attached to the main section a predetermined distance from the rear portion to extend beyond the seat base.

3. The object catching device of claim 1, wherein the main section has an opening distal to the rear portion on at least one of the sides to allow for a seat belt to pass through.

4. The object catching device of claim 1, wherein the upper edge of the rear portion is elastic.

5. The object catching device of claim 1, wherein the front portion has at least two elongated straps.

6. The object catching device of claim 5, wherein each of the at least two elongated straps has a fastening mechanism to secure the front portion to a structure.

7. The object catching device of claim 6, wherein the fastening mechanism is a hook and loop style fastener.

8. The object catching device of claim 1, wherein the interior surface of the main section is covered in a water resistant coating.

9. The object catching device of claim 1, wherein the exterior surface of the main section is covered in a water resistant coating.

10. The object catching device of claim 1, wherein the main section is a unitary design.

11. A object catching device for use in transportation vehicle, comprising:
a main section having a generally rectangular shape, the main section adapted to cover the area between two seats and the main section having a rear portion adapted to secure to the back portion of a seat, the front portion adapted to secure in front of a seat, and the side portions to extend upwards a predetermined height, a pouch attached to the main section a predetermined distance from the rear portion to extend beyond the seat base, and a plurality of openings distal to the rear portion.
